(19) United States
(12) Patent Application Publication
(10) Pub. No.: US 2011/0304791 A1
(43) Pub. Date: Dec. 15, 2011

(54) DISPLAY DEVICE

(76) Inventors: HIROKI TAKAHASHI, KANAGAWA (JP); YOICHI HIROSE, TOKYO (JP)

(21) Appl. No.: 13/153,258

(22) Filed: Jun. 3, 2011

(30) Foreign Application Priority Data
Jun. 10, 2010 (JP) P2010-132995

(51) Int. Cl. G02F 1/1333

(52) U.S. Cl. 349/58

(57) ABSTRACT

A display device includes: a first board; a second board including a transparent substrate larger in size than the first board, and including, on a back of the transparent substrate, a first region where the first board overlays the transparent substrate and a second region where the transparent substrate lies off the first board; and a connection member connected to the terminal section and disposed within an outer shape of the second board. The first region is provided with a first shading layer, a driving element, and a display element in this order and the second region is provided with a second shading layer and a terminal section connected to the driving element in this order.

### BACKGROUND

The present technology relates to a display device suitable for a television device or an information terminal.

As described in, for example, Japanese Unexamined Patent Application Publications No. 61-143791 and No. 61-143789, a liquid crystal display device in related art has such a structure that a TFT (Thin Film Transistor) board having TFTs and picture element electrodes is disposed to face an opposed board having a color filter, a black matrix, and a transparent electrode, and the opposed board side serves as the front side of the liquid crystal display. The outer edge of the opposed board is covered with a frame-shaped member called bezel (peripheral enclosure).

### SUMMARY

In recent years, for display devices such as television devices in particular, a structure in which the bezel (peripheral enclosure) is eliminated and the front surface is flat has been already well on its way to becoming mainstream. However, in order to make the front surface flat in the display device in which the opposed board side serves as the front surface of the display device, it is desirable to dispose a front glass plate outside of the opposed board, which increases the costs of components and production.

In view of the foregoing, it is desirable to provide a display device that may realize a structure in which the front surface is flat without the front glass plate.

A display device according to an embodiment of the present technology includes the following components (A) to (C).
(A) A first board.
(B) A second board including a transparent substrate larger in size than the first board, and including, on a back of the transparent substrate, a first region where the first board and the transparent substrate overlap and a second region where the transparent substrate lies off the first board, the first region being provided with a first shading layer, a driving element, and a display element in this order, and the second region being provided with a second shading layer and a terminal section connected to the driving element in this order.
(C) A connection member connected to the terminal section and disposed within an outer shape of the second board.

In the display device according to the embodiment of the present technology, the size of the transparent substrate of the second board is larger than that of the first board, and the first region where the first board and the transparent substrate overlap and the second region where the transparent substrate lies off the first board are provided. In the first region, the first shading layer, the driving element, and the display element are provided in this order and thus, external light is absorbed by the first shading layer, and a decline in contrast due to external light reflection is suppressed. In the second region, the second shading layer and the terminal section are provided in this order, and the connection member connected to the terminal section is disposed within the outer shape of the second board and therefore, the connection member does not lie off the outer shape of the second board, and an inner structure is covered by the second shading layer, and thereby the bezel (peripheral enclosure) of the past may be needless.

In the display device according to the embodiment of the present technology, the size of the transparent substrate of the second board is larger than that of the first board, and the first region where the first board and the transparent substrate overlap and the second region where the transparent substrate lies off the first board are provided. The first shading layer, the driving element, and the display element are provided in this order in the first region, the second shading layer and the terminal section are provided in this order in the second region, and the connection member connected to the terminal section is disposed within the outer shape of the second board. Therefore, there may be no need to add a glass plate to the outside of the second board, and the second board itself may be used as the front surface of the display device. Accordingly, the cost of the glass plate for the front surface as in the past may be reduced, and a structure in which the front surface is flat may be realized.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a cross-sectional diagram schematically illustrating the entire structure of a display device according to a first embodiment of the present technology.

FIG. 2 is a plan view illustrating a configuration in which a second board illustrated in FIG. 1 is viewed from where a first board is disposed.

FIG. 3 is a cross-sectional diagram illustrating a modification of FIG. 1.

FIG. 4 is a plan view illustrating a configuration of the first board illustrated in FIG. 1.

FIG. 5 is a cross-sectional diagram taken along a line V-V in FIG. 4.

FIG. 6 is a plan view illustrating a configuration of a first region of the second board.

FIG. 7 is a cross-sectional diagram taken along a line VII-VII in FIG. 6.

FIG. 8 is a plan view for explaining a region where a first shading layer illustrated in FIG. 7 is provided.

FIG. 9 is a cross-sectional diagram illustrating a configuration of a second region of the second board.

FIG. 10 is a perspective diagram for explaining a way of holding the second board, the first board, and a back light unit illustrated in FIG 1.

FIG. 11 is a cross-sectional diagram illustrating the entire structure of a display device in related art.

FIG. 12 is a plan view illustrating a configuration of a first region of a second board in a display device according to a second embodiment of the present technology.

FIG. 13 is a cross-sectional diagram taken along a line XIII-XIII in FIG. 12.

### DETAILED DESCRIPTION

Embodiments of the present technology will be described below in detail with reference to the drawings. Incidentally, the description will be provided in the following order.
1. First embodiment (an example in which a first shading layer is formed by a photolithography process separately from other layers
2. Second embodiment (an example in which a first shading layer is formed by the same photolithography process as that of a gate electrode scanning line)

### First Embodiment

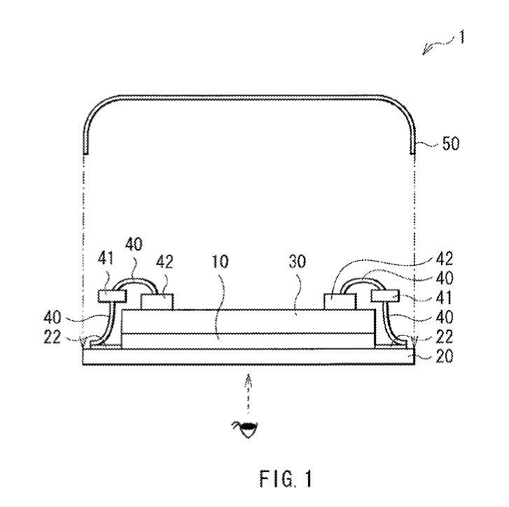

FIG. 1 illustrates the entire structure of a display device according to a first embodiment of the present technology. A display device 1 is used, for example, as a television device or an information terminal. The display device 1 is a liquid crystal device including a first board 10, a second board 20, and a back light unit (BLU) 30. The second board 20 is a so-called TFT (Thin Film Transistor) board having TFTs and picture element electrodes. The first board 10 is a so-called opposed board having a transparent electrode. The second board 20 that is the TFT board is disposed at the front surface of the display device 1 from a viewer's pint.

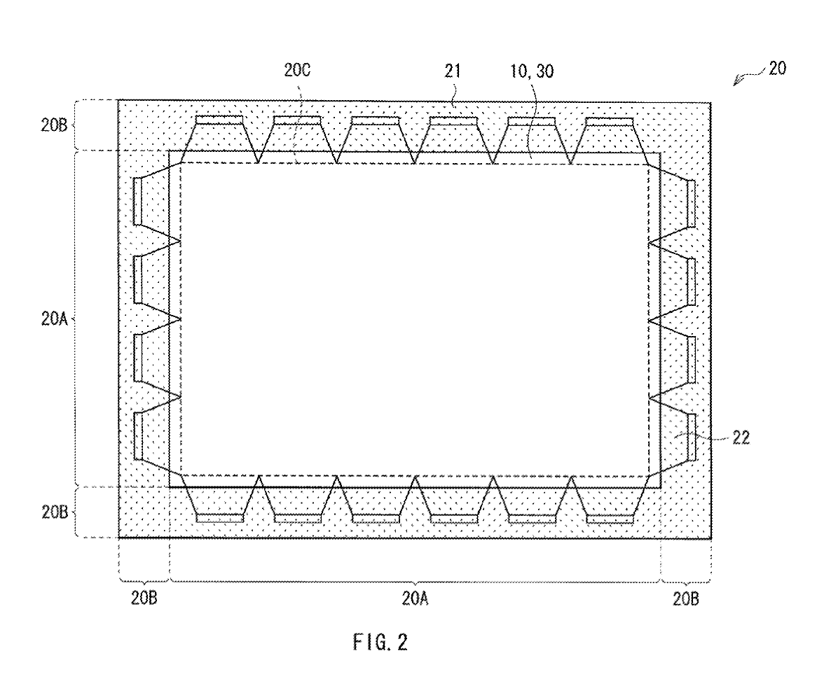

FIG. 2 illustrates a planar structure when the second board 20 is viewed from the side where the first board 10 and the back light unit 30 are disposed. The second board 20 has a transparent substrate 21 formed of a glass substrate or the like. The transparent substrate 21 is larger in size than the first board 10. On the back of the transparent substrate 21, there are provided: a first region 20A in which the first board 10 and the transparent substrate 21 overlap; and a second region 20B (a shaded region in FIG. 2) in which the transparent substrate 21 protrudes from the outer edge of the first region 20A to lie off the first board 10. For example, the second region 20B is provided on the outer edge of the transparent substrate 21, and shaped like a frame surrounding the first region 20A. It is desirable that the width of the second region 20B be equivalent to that of the bezel of the past, e.g., around 30 mm.

The first region 20A has the effective screen 20C where a picture image or moving image is to be displayed. In this effective screen 20C, a first shading layer to be described later, the TFTs serving as driving elements, and liquid crystal display elements are provided on the transparent substrate 21 in this order from the transparent substrate 21 side.

In the second region 20B, a second shading layer to be described later and a terminal section 22 connected to the TFTs are provided on the transparent substrate 21 in this order from the transparent substrate 21 side. The terminal section 22 is provided, for example, over the second region 20B from the edge of the effective screen 20C within the first region 20A. The terminal section 22 is bundled by a plurality of terminals within the second region 20B to configure a mounting pad. There is also a case in which the terminal section 22 to which gate drivers on the right and left sides of the transparent substrate 21 are connected are not mounted, and instead, a driver circuit formed by COG (Chip on Glass) is provided on the transparent substrate 21.

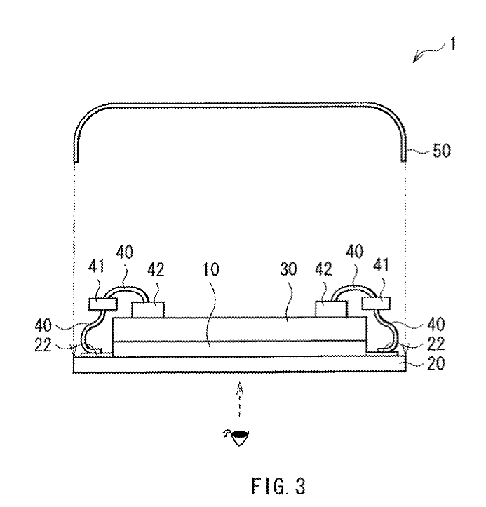

As illustrated in FIG. 1, for example, the terminal section 22 is connected to a driver circuit board 41 and a control circuit board 42 on the back of the first board 10 via a connection member 40 made of, for example, COF (Chip On Film). The connection member 40 is mounted within the outer shape of the second board 20. Specifically, the connection member 40 may have a shape warped inward as illustrated in FIG. 1, or a shape warped outward as illustrated in FIG. 3. The shape of the connection member 40 may be adjusted by, for example, selecting a way of affixation to the terminal section 22 or selecting a material for COF. In either case, in order to secure reliability of bonding to the terminal section 22, it is desirable to sufficiently warp the connection member 40 beforehand, thereby relieving the stress.

The entire back of the second board 20 is covered with an enclosure 50, and the first board 10, the back light unit 30, the connection member 40, the driver circuit board 41, and the control circuit board 42 are stored in the space surrounded by the enclosure 50 and the second board 20.

The first board 10 and the second board 20 configuring the first region 20A and the second region 20B will be described below.

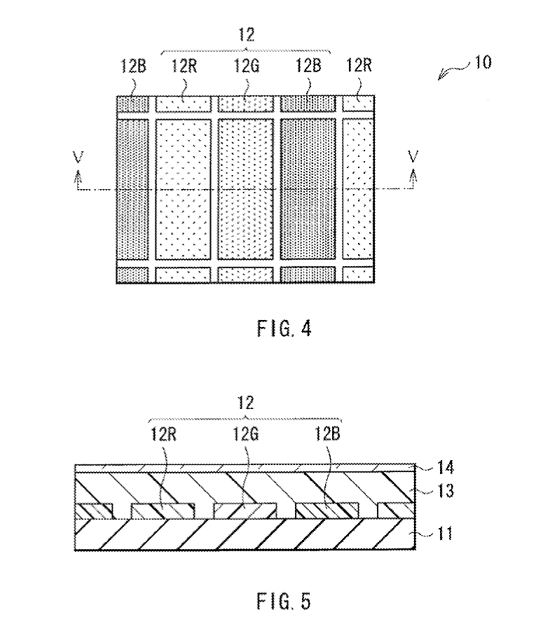

FIG. 4 illustrates an enlarged part of the first board 10, and FIG. 5 illustrates a cross-sectional structure of the part. The first board 10 has a color filter 12, an overcoat layer 13, and a transparent electrode 14 in this order on the second board 20 side of a rear substrate 11 formed of a glass substrate or the like. As the color filter 12, a red filter 12R, a green filter 12G, and a blue filter 12B are disposed sequentially. The red filter 12R, the green filter 12G, and the blue filter 12B are each made of a resin mixed with a pigment, and are each adjusted to increase the luminous transmittance in the wavelength region of intended red, green, or blue and decrease the luminous transmittance in other wavelength regions, by selecting the pigment. The red filter 12R, the green filter 12G, and the blue filter 12B may be spaced apart at an interval larger than the width of a first shading layer 23A to be described later, in a range considering misalignment in bonding between the second board 20 and the first board 10, or may overlap one another. The overcoat layer 13 is intended to improve flatness of the surface of the rear base 11 provided with the color filter 12, and is made of an acrylic resin, an epoxy resin, or the like. The transparent electrode 14 is made of, for example, a transparent conductive material such as ITO (Indium Tin Oxide).

The color filter 12 may be provided on the second board 20, instead of being provided on the first board 10. In this case, the overcoat layer 13 may not be needed on the first board 10 and thereby the production cost may be reduced.

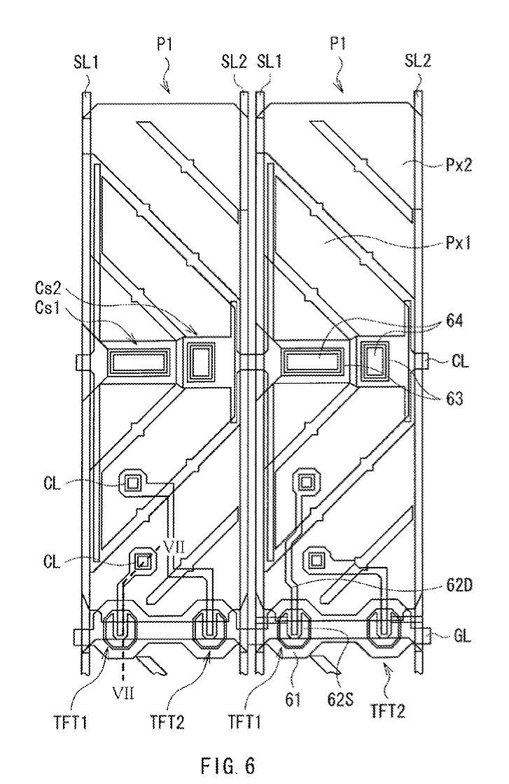

FIG. 6 illustrates an example of the configuration of the first region 20A of the second board 20. The first region 20A has a plurality of pixels P1 disposed in the form of a matrix, but in FIG. 6, the first region 20A is represented by the two pixels P1 as an example. For instance, the pixel P1 has a TFT1, a TFT2, a picture element electrode PX1 configuring one subpixel (hereinafter may be referred to as a subpixel A), a picture element electrode PX2 configuring another subpixel (hereinafter may be referred to as a subpixel B), and capacitive elements Cs1 and Cs2. It goes without saying that the pixel P1 may have other configuration.

Each of the TFT1 and the TFT2 has a function as a switching element to supply an image signal to the subpixels A and B, and is configured of a MOS-FET (Metal Oxide Semiconductor-Field Effect Transistor), for example, and has three electrodes; gate, source, and drain. The gate electrode 61 of each of the TFT1 and the TFT2 is connected to a gate-electrode scanning-line (scanning line) GL extending laterally. Two vertically extending source wires (signal lines) SL1 and SL2 intersect (for example, at right angles) the gate electrode scanning line GL. The source electrode 62S of the TFT1 is connected to the source wire SL1, and the drain electrode 62D of the TFT1 is connected to the picture element electrode PX1 and also connected to an intermediate electrode 63 of the capacitive element Cs1 via a contact hole 64. The source electrode 62S of the TFT2 is connected to the source wire SL2, and the drain electrode 62D of the TFT2 is connected to the picture element electrode PX2 and also connected to an intermediate electrode 63 of the capacitive element Cs2 through a contact hole 64.

The picture element electrodes PX1 and PX2 configure, together with the transparent electrode 14 on the first board 10, the liquid crystal display element performing operation for display according to signal voltages supplied via the TFT1 and the TFT2.

The capacitive elements Cs1 and Cs2 are provided between the above-described intermediate electrode 63 and a capacitive element main wire CL, and produce a potential difference between both ends. The capacitive element main wire CL extends, for example, in parallel with the gate electrode scanning line GL, namely, in the lateral direction.

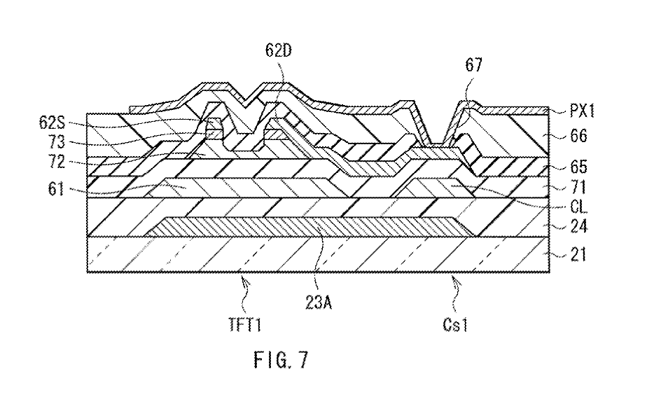

FIG. 7 illustrates an example of the cross-sectional structure of the TFT1, the capacitive element Cs1, and the picture element electrode PX1. The TFT2, the capacitive element Cs2, and the picture element electrode PX2 are similarly configured and thus will not be described. In the first region 20A, the first shading layer 23A, an overcoat layer 24, the TFT1 and the capacitive element Cs1, a protective film (passivation film) 65, an overcoat layer 66, and the picture element electrode PX1 are provided on the transparent substrate 21 in this order.

The first shading layer 23A is provided on the surface of the transparent substrate 21, namely, as the lowermost layer. The first shading layer 23A is allowed to absorb external light incident from the second board 20 side and to reduce a decline in contrast due to external light reflection. As a material configuring the first shading layer 23A, a similar material used for a black matrix in the past, for example, a black-colored photosensitive resin or a low-reflection laminated film of chrome (Cr), or the like may be employed.

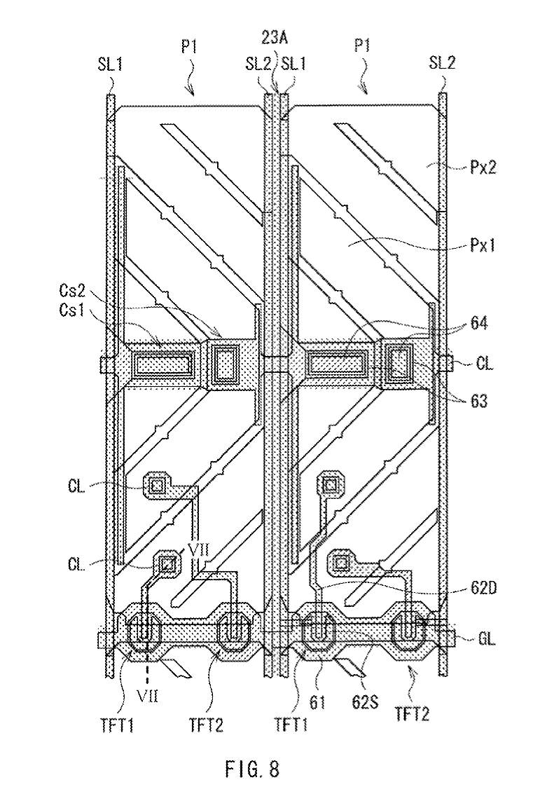

It is desirable that the first shading layer 23A be provided in the form of a lattice along the outer shape of each of the pixels P1, specifically, as indicated by a shaded area illustrated in FIG. 8, in a position corresponding to a layer under the gate electrode scanning line GL, the source wires SL1 and SL2, the capacitive-element main wire CL, and the drain electrode 62D. This is because the external light incident from the second board 20 side may be mostly prevented from being reflected by those wires.

The overcoat layer 24 illustrated in FIG. 7 is provided as needed, and is made of an acrylic resin, an epoxy resin, or the like. Each of the gate electrode scanning lines GL is desired to be electrically independent. However, when the material configuring the first shading layer 23A is conductive, or when it is difficult to make the gate electrode scanning line GL electrically independent to a sufficient degree, it is desirable to provide the overcoat layer 24 as an interlayer dielectric film. Further, when the first shading layer 23A is made of a resin, it is desirable to provide a capping film (not illustrated) made of silicon nitride (SiNx) or the like, in order to reduce outgassing and ion elution. Furthermore, in particular, when a black exposure resin is used, a film thickness becomes large and thus, it is desirable to provide the overcoat layer 24 as a flattening film.

The TFT1 illustrated in FIG. 7 has, for example, the gate electrode 61 as well as the capacitive-element main wire CL, a gate insulating film 71, an a-Si (amorphous silicon) layer 72, a n+a-Si layer 73, and the source electrode 62S as well as the drain electrode 62D in this order. A passivation film 65 is made of, for example, silicon nitride (SiNx). The overcoat layer 66 is made of for example, a resin material. The picture element electrode PX1 is made of, for example, ITO and connected to the drain electrode 62D via a contact hole 67.

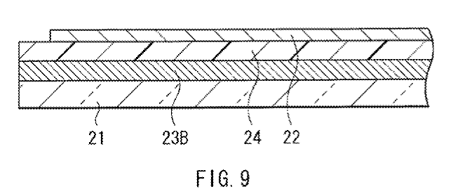

FIG. 9 illustrates a cross-sectional structure of the second region 20B. In the second region 20B, a second shading layer 23B, the overcoat layer 24, and the terminal section 22 are provided in this order on the transparent substrate 21. As mentioned earlier, the overcoat layer 24 here is provided as needed. The second shading layer 23B is provided to hide the inner structure by making the surrounding part of the first region 20A black, and is disposed, for example, like a frame on the entire second region 20B. In other words, the second shading layer 23B has a function equivalent to the bezel (peripheral enclosure) of the past. Therefore, by providing the second shading layer 23B and disposing the connection member 40 within the outer shape of the second board 20, the bezel (peripheral enclosure) of the past may be eliminated, and there may be realized a design in which the front surface is flat since the second board 20 itself serves as the front surface of the display device 1. As a material for configuring the second shading layer 23B, the material similar to that of the first shading layer 23A, for example, either the black-colored photosensitive resin or the low-reflection laminated film of chrome (Cr) or the like may be employed.

This display device 1 may be produced as follows, for example.

First, as illustrated in FIG. 7, FIG. 2, and FIG. 9, the transparent substrate 21 formed of a glass substrate or the like is prepared, the first shading layer 23A is formed in the first region 20A of this transparent substrate 21, and the second shading layer 23B is formed in the second region 20B. The first shading layer 23A and the second shading layer 23B may be formed by, for example, applying a coating of a black-colored resin, patterning by a photolithography process, and burning, or a low-reflection laminated film made of chrome (Cr) or the like may be formed.

It is desirable that the first shading layer 23A be provided in the form of a lattice along the outline of each pixel P1. Specifically, as illustrated in FIG. 8, it is desirable to provide the first shading layer 23A in a position corresponding to a layer under the gate-electrode scanning-line GL, the source wires SL1 and SL2, the capacitive-element main wire CL and the drain electrode 62D. This is because the external light incident from the second board 20 side may be mostly prevented from being reflected by those wires.

Subsequently, as illustrated similarly in FIG. 7 and FIG. 9, the overcoat layer 24 made of the material mentioned above is formed as needed over the entire surface of the transparent substrate 21 on which the first shading layer 23A and the second shading 23B are formed.

Subsequently, as illustrated similarly in FIG. 7, the gate electrode scanning line GL including the gate electrode 61 and the capacitive element main wire CL are formed on the overcoat layer 24. Next, the gate insulating film 71, the a-Si (amorphous silicon) layer 72, the n+a-Si layer 73, the source electrode 62S as well as the drain electrode 62D, the intermediate electrode 63, and the source wires SL1 and SL2 are formed sequentially. As a result, the TFT1, the TFT2 and the capacitive elements Cs1 and Cs2 are formed in the first region 20A. The gate electrode scanning line GL, the source wires SL1 and SL2, and the capacitive element main wire CL may be extended up to the second region 20B as needed to form the terminal section 22.

After the TFT1, the TFT2, and the capacitive elements Cs1 and Cs2 are formed, the passivation film 65 and the overcoat layer 66 are formed on the entire surface, and the contact hole 67 is formed in the passivation film 65 and the overcoat layer 66. Subsequently, the picture element electrodes PX1 and PX2 are formed on the overcoat layer 66, and the picture element electrodes PX1 and PX2 are connected to the drain electrode 62D via the contact hole 67. In this way, the second board 20 illustrated in FIG. 7 to FIG. 9 is formed.

Further, as illustrated in FIG. 4 and FIG. 5, the rear base 11 made of a glass substrate or the like is prepared, and then the color filter 12, the overcoat layer 13, and the transparent electrode 14 are formed sequentially on this rear base 11, and thereby the first board 10 is formed.

After the second board 20 and the first board 10 are formed, an alignment film (not illustrated) made of polyimide or the like is formed for each of the second board 20 and the first board 10, a liquid crystal (not illustrated) is interposed by a dropping method or the like, and as illustrated in FIG. 1 and FIG. 2, the first board 10 is disposed to overlap the first region 20A of the second board 20, and the periphery is sealed. Subsequently, a polarizing plate (not illustrated) is affixed to the back of the first board 10 and the front of the second board 20. Then, the connection member 40 molded beforehand to be in the shape illustrated in FIG. 1 or FIG. 3 is subjected to thermocompression bonding, and the driver circuit board 41 is subjected to thermocompression bonding likewise to the side opposite to the connection member 40. At the time, the connection member 40 is disposed within the outer shape of the second board 20. Subsequently, the back light unit 30 is disposed on the back of the first board 10, and the control circuit board 42 is mounted on the back of the back light unit 30.

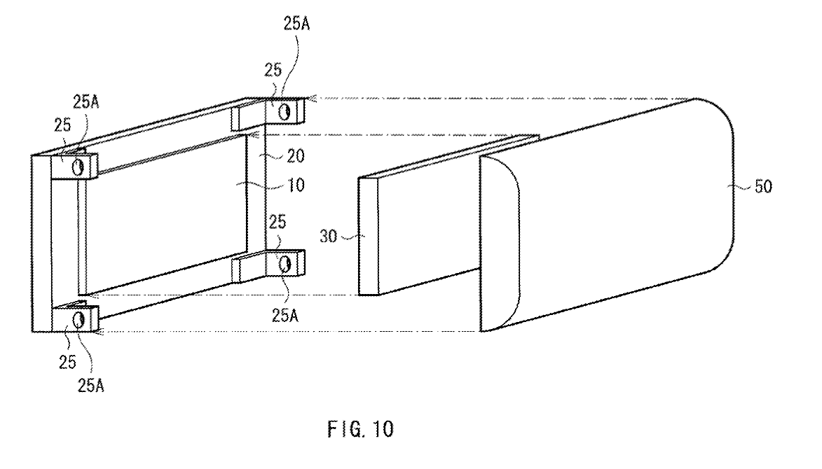

Afterwards, as illustrated in FIG. 1, the enclosure 50 is placed over the entire back of the second board 20, and the first board 10, the back light unit 30, the connection member 40, the driver circuit board 41, and the control circuit board 42 are stored in the enclosure 50. As for a method of fixing the enclosure 50, as illustrated in, for example, FIG. 10, it is desirable that metal members 25 each shaped like a letter L in cross section and having a through-hole 25A on the outer edge of the rear transparent substrate 21 of the second board 20, and the enclosure 50 and the like be fixed to these metal members 25. FIG. 10 illustrates a case in which the metal members 25 are provided at only the four corners of the transparent substrate 21, but the metal members 25 may be extended along a side of the transparent substrate 21. This completes the display device 1 illustrated in FIG. 1 to FIG. 9.

Incidentally, it is desirable that a polarizing plate (not illustrated) be affixed to the entire outer surface of the second board 20 to provide integrity.

In the display device 1, the transparent substrate 21 of the second board 20 is larger in size than the first board 10, and the first shading layer 23A, the TFT1, the TFT2, and the liquid crystal display element including the picture element electrodes PX1 and PX2 and the transparent electrode 14 are provided in this order in the first region 20A. The transparent substrate 21 and the first board 10 overlap, and the effective screen 20 is included in the first region 20A. Therefore, the external light incident from the second board 20 side is absorbed by the first shading layer 23A, and a decline in contrast due to the external light reflection may be suppressed. On the other hand, in the second region 20B where the transparent substrate 21 protrudes from the outer edge of the first region 20A to lie off the first board 10, the second shading layer 23B and the terminal section 22 are provided in this order, and the connection member 40 connected to the terminal section 22 is disposed within the outer shape of the second board 20. Therefore, the connection member 40 does not lie off the outer shape of the second board 20, and the inner structure is covered by the second shading layer 23B. Therefore the bezel (peripheral enclosure) of the past may be needless.

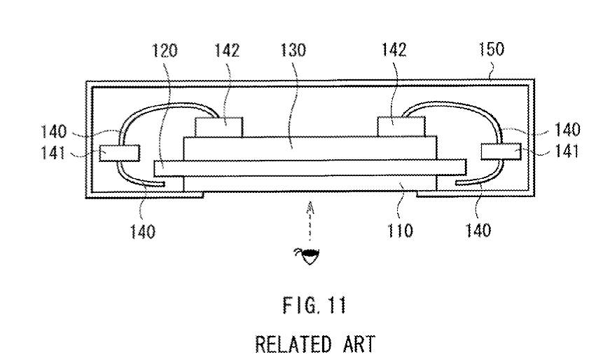

In contrast, as illustrated in, for example, FIG. 11, a display device of the past has a structure in which an opposed board 110 side serves as the front surface of the display device. This is because processes of film formation, pattern formation etc. of a TFT board 120 are complicated as compared to a relatively simple process of producing the opposed board 110 and thus, yield is not high. Therefore, the processes are separated even to a small extent, and a black matrix and a color filter are provided on the opposed board 110 side. However, nowadays, the yield of the TFT board is sufficiently high and thus, it is unlikely that the yield sharply drops when, like the present embodiment, the first shading layer 23A and the second shading layer 23B are provided on the second board 20 serving as the TFT board.

In addition, in the display device of the past, a connection member 140 generally lies off the outer shape of the TFT board 120 and has a shape gently warped toward the rear face. Therefore, the width of a bezel 150 is desired to be large to some extent. On the other hand, in the present embodiment, the connection member 40 is disposed within the outer shape of the second board 20 and thus, the second region 20B serving as a frame may be narrow.

In this way, in the present embodiment: the transparent substrate 21 of the second board 20 is larger in size than the first board 10, and the first shading layer 23A, the TFT1, the TFT2, and the liquid crystal display element are provided in this order in the first region 20A where the transparent substrate 21 and the first board 10 overlap, and the effective screen 20 is included. On the other hand, the second shading layer 23B and the terminal sections 22 are provided in the second region 20B where the transparent substrate 21 protrudes from the outer edge of the first region 20A to lie off the first board 10, and the connection member 40 connected to the terminal section 22 is disposed within the outer shape of the second board 20. Therefore, it may be unnecessary to add a glass plate to the outer side of the second board 20, and the second board 20 itself may be used as the front surface of the display device 1. Accordingly, the costs of components and production may be reduced, and a structure in which the front surface is flat may be realized. Further, by the structure in which the front surface is flat, high-grade sense and glossiness are provided, and thereby quality in design may be improved. In addition, since the display panel including the second board 20 and the first board 10 may not be sealed by a front glass plate, a rise in the temperature of the display panel may be avoided, and a decline in luminance or a problem in reliability caused by the rise in the temperature may be evaded.

### Second Embodiment

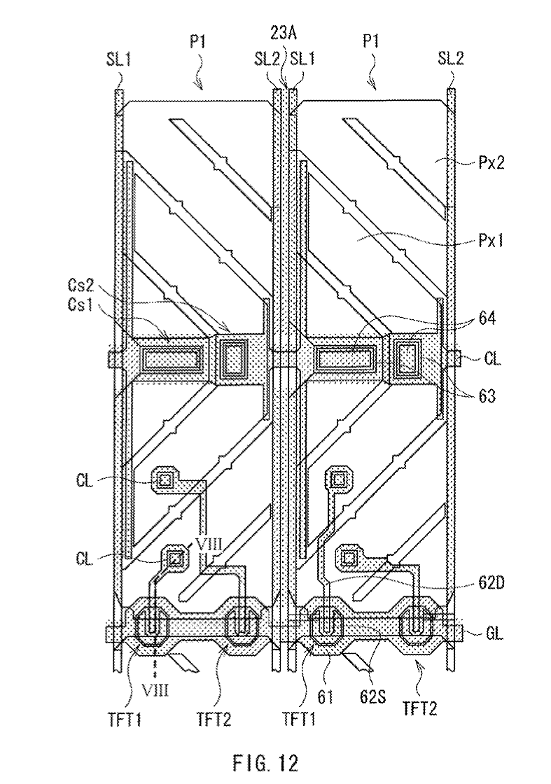

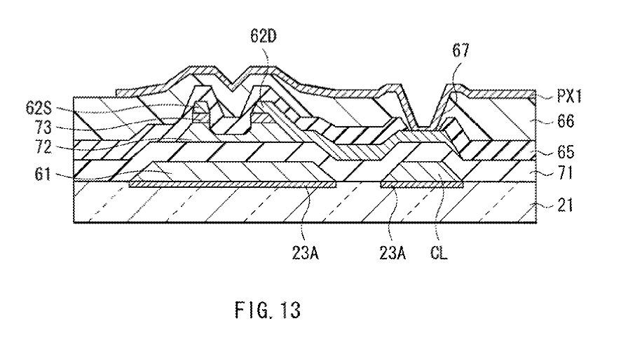

FIG. 12 and FIG. 13 illustrate a configuration of the first region of a second board of a display device according to a second embodiment of the present technology. FIG. 12 illustrates a region where the first shading layer is provided in the first region, and FIG. 13 illustrates a cross-sectional structure of this region. In the present embodiment, the first shading layer 23A is made of a low-reflection laminated film of chrome (Cr), and the first shading layer 23A and wires such as the gate electrode scanning line GL are directly laminated and thus allowed them to be patterned in the same process. Otherwise, this display device according to the second embodiment has a structure, operation and effects similar to those of the first embodiment, and may be produced in a manner similar to that of the first embodiment. Therefore, the elements equivalent to those of the first embodiment are provided with the same reference characters as those of the first embodiment.

In the present embodiment, as indicated by a shaded area in FIG. 12, the first shading layer 23A is provided immediately below: the gate electrode scanning line GL, the capacitive element main wire CL, a part of the drain electrode 62D except a position intersecting the gate electrode scanning line GL, and a part of the source wires SL1 and SL2 except a position intersecting the gate electrode scanning line GL or the capacitive element main wire CL. The overcoat layer 24 is not provided. As a result, in the present embodiment, the first shading layer 23A and wires such as the gate electrode scanning line GL, the capacitive element main wire CL, and the like may be patterned in the same process and therefore, a reduction in cost by reducing the number of masks may be achieved. In the present embodiment, the first shading layer 23A is not shaped like a complete lattice along the outer shape of the pixel P1 as in the first embodiment and thus, the external light reflection may increase slightly, but the light from the back light unit 30 may be blocked by the source wires SL1 and SL2.

The display device 1 may be produced as follows, for example.

First, as illustrated in FIG. 12 and FIG. 13, a laminated film of chrome (Cr) is formed on the surface of the transparent substrate 21 and subsequently, a metallic film that becomes a wiring material of the gate electrode scanning line GL and the like is formed. Next, a mask is formed by resist coating, exposure, and development, and wires such as the gate electrode scanning line GL, the capacitive element main wire CL, and the like are formed by etching the metallic film by using this mask and subsequently, the first shading film 23A is formed by etching the laminated film of chrome (Cr).

Subsequently, as in the first embodiment, a gate insulating film 71 and the subsequent elements are formed, and thereby the second board 20 is formed. Further, the first board 10 is formed as in the first embodiment, and after formation of the alignment film and liquid crystal dropping, the first board 10 is overlaid on the first region 20A of the second board 20, and the periphery is sealed. Thermocompression bonding of the connection member 40 and the like is performed, the connection member 40 is mounted within the outer shape of the second board 20, the back light unit 30 is disposed, and the entire back of the second board 20 is covered with the enclosure 50. This completes the display device 1 illustrated in FIG. 12 and FIG. 13.

Although the present technology has been described in the foregoing by way of example with reference to the embodiments, the present technology is not limited thereto and may be variously modified. For example, the embodiments have been described by using the case in which the color filter 12 is provided at the first board 10, but the color filter may be provided at the second board 20 side. In addition, the embodiments have been described by using the case in which the back light unit 30 is provided on the back of the first board 10, but the back light unit 30 may be of a type to be provided on the side of the first board 10.

Further, the embodiments have been described by taking the liquid crystal display device having the second board 20, the first board 10, and the back light unit 30 as an example, but the present technology may be applied to other display devices such as an organic electroluminescence display device and a plasma display device.

The present application contains subject matter related to that disclosed in Japanese Priority Patent Application JP 2010-132995 filed in the Japan Patent Office on Jun. 10, 2010, the entire content of which is hereby incorporated by reference.

It should be understood by those skilled in the art that various modifications, combinations, sub-combinations and alternations may occur depending on design requirements and other factors insofar as they are within the scope of the appended claims or the equivalents thereof.

What is claimed is:

1. A display device comprising:
a first board;
a second board including a transparent substrate larger in size than the first board, and including, on a back of the transparent substrate, a first region where the first board overlays the transparent substrate and a second region where the transparent substrate lies off the first board, the first region being provided with a first shading layer, a driving element and a display element in this order, and the second region being provided with a second shading layer and a terminal section connected to the driving element in this order; and
a connection member connected to the terminal section and disposed within an outer shape of the second board.

2. The display device according to claim 1, wherein a scanning line and a signal line connected to the driving element are provided in respective directions crossing each other, and the first shading layer is provided under at least the scanning line of the scanning line and the signal line.

3. The display device according to claim 2, further comprising:
an enclosure covering an entire back of the second board and housing the first board and the connection member.

4. The display device according to claim 3, wherein the display device is a liquid crystal display device including the second board, the first board and a back light unit.
